(19) United States
(12) Patent Application Publication
(10) Pub. No.: US 2004/0120017 A1
(43) Pub. Date: Jun. 24, 2004

(54) Method and apparatus for compensating for assembly and alignment errors in sensor assemblies

(76) Inventor: Mindy Lee Miller, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/327,168

(22) Filed: Dec. 20, 2002

(51) Int. Cl. H04N 1/04

(52) U.S. Cl. 358/474; 358/486

(57) ABSTRACT

A method and apparatus are disclosed for compensating for assembly and alignment errors in multi-segment sensor assemblies. The placement of each sensor segment is characterized by the coordinates of its end pixels in scanner pixel space. For each pixel in each segment, an offset is computed, using the segment's slope and first pixel location, indicating the number of scan lines the pixel should be shifted to place its data in the image pixel nearest its ideal location. During scanning of an image, image data is placed in a buffer. Upon placement in the buffer or placement into a final output destination, image data from each interval of the segment is shifted by a distance in the subscanning direction that minimizes image artifacts. In an alternative embodiment, interpolation is performed between two adjacent scan lines. The data from two overlapping segments may optionally be smoothed by combining data from redundant pixels.

### FIELD OF THE INVENTION

The present invention relates generally to image input scanning.

### BACKGROUND OF THE INVENTION

A typical scanner uses a light source to illuminate a section of an original item. A lens or an array of lenses redirects light reflected from or transmitted through the original item so as to project an image of a scan line onto an array of light-sensitive elements. Each light-sensitive element produces an electrical signal related to the intensity of light falling on the element, which is in turn related to the reflectance, transmittance, or density of the corresponding portion of the original item. These electrical signals are read and assigned numerical values. A scanning mechanism typically sweeps the scan line across the original item, so that successive scan lines are read. By associating the numerical values with their corresponding locations on the item being scanned, a digital representation of the scanned item is constructed. When the digital representation is read and properly interpreted, an image of the scanned item can be reconstructed.

FIG. 1 depicts a perspective view of the imaging portion of a scanner using a contact image sensor. Much of the supporting structure, light shielding, and scanning mechanism have been omitted from the figure for clarity. A contact image sensor (CIS) uses an array of gradient index (GRIN) rod lenses 101 placed between a platen 102 and a segmented array of sensor segments 103 mounted on a printed circuit board 104. The sensor segments 103 contain the light-sensitive elements. A light source 105 provides the light needed for scanning of reflective original items. The electrical signals generated by the light-sensitive elements may be carried to other electronics (not shown) by cable 106. Each sensor segment 103 may sometimes be called a die.

FIG. 2 depicts a cross-section view of the CIS arrangement of FIG. 1, as it would be used to scan a reflective original. Light source 105 emits light 201, which illuminates the original 202. Some of the light reflects from the original and is captured by GRIN lenses 101. The GRIN lenses refocus the light onto light-sensitive elements 103, forming an image of the original 202. While an array of GRIN lenses comprising two staggered rows is shown, the lenses may be arranged in a single row, three rows, or some other arrangement.

Each of light-sensitive segments is further divided into pixels. The term pixel may refer to an individually addressable light-sensitive element of sensor segments 103, or to the corresponding area of original 202 that is imaged onto that portion, or the each digital value corresponding to a location in a digital image.

FIG. 3 depicts a schematic plan view of a particular sensor segment 103, also showing the row of individual pixels 301 that each sensor segment 103 comprises. For clarity of illustration, only a few pixels are shown. An actual sensor segment may comprise hundreds or thousands of individual pixels. The number of pixels per linear unit of sensor defines the scanner's spatial sampling rate, which is also often called the scanner's resolution. A typical scanner may have a resolution of 300, 600, 1200, or 2400 pixels per inch, although other resolutions are possible.

The optical magnification of the CIS module is essentially unity, so the pixel sites 301 on sensor segments 103 are mapped to corresponding pixels on the original 202, and the pixels on original 102 are essentially the same size as the pixel sites 301. FIG. 4 depicts the pixels from three sensor segments of a multi-segment sensor array as projected onto the original 202. Ideally, some of the pixels of the segments overlap. That is, if the direction corresponding to the length of the segments, the X direction, is considered to define a row of pixels, and the transverse direction, the Y direction is thought to traverse columns of pixel locations, then the end pixel or pixels of one segment may be in the same column as the end pixels of another segment. For example, pixel 411 in segment 402 is essentially in the same column as pixel 410 in segment 401.

The X direction as shown is also sometimes called the main scanning direction, and the Y direction is sometimes called the subscanning direction.

During scanning, the set of segments is moved in the subscanning direction indicated by arrow 404. At one time, the pixels are in the position as shown in solid lines in FIG. 4 and are read. At later times corresponding to successive scan lines, the pixels are in the positions shown in dashed lines and are read. At a particular later time, pixel 410 will read essentially the same portion of original 202 that pixel 411 read earlier. This is a simple example of the process of constructing a complete final image from segments scanned at different times and locations. This process is sometimes called re-sampling or stitching.

In the idealized example of FIG. 4, the sensor segments 103 are placed perfectly parallel to each other, overlapped by exactly one pixel, and offset in the Y direction by exactly 3 pixels. In an actual scanner, however, this precision is not generally achievable. The positional accuracy of the pixels is determined primarily by the placement accuracy of the sensor segments 103 on circuit board 104. Each segment may be displaced from its ideal location in the X direction or the Y direction, or by being placed non-parallel to its ideal alignment. These errors may occur in any combination.

FIG. 5 depicts an exaggerated example of misplacement of the sensor segments 103. Each of segments 501, 502, and 503 is misplaced relative to its nominal position. One example result is that pixels 510 and 511 are displaced by about five scan lines in the Y direction rather than their nominal three scan lines. If the stitching means assumes that it should match pixels from segment 510 with pixels from segment 511 scanned three scan lines earlier, there will occur a “stitching artifact” at the boundary between the parts of the image scanned by segments 501 and 502. Segments 502 and 503 overlap in the X direction more than their nominal one pixel, and similar stitching artifacts may occur as a result. For example the stitching artifacts may cause smooth lines in the original 202 to appear disjointed or jagged in the resulting scanned image.

Previously, manufacturers of CIS modules have endeavored to avoid these stitching artifacts by controlling the placement of the sensor segments 103 onto the circuit board 104 as precisely and accurately as possible. Because the geometries involved are very small, it has not always been possible to reliably place the segments with errors small enough. Typically, modules with too much placement deviation have been rejected, reducing the manufacturing yield and ultimately increasing the cost of the modules that were acceptable.

This problem has been exacerbated as scanners have been produced with increasingly higher resolution. For example, a specification of a one pixel maximum placement error corresponds to a placement tolerance of about 84 microns for a scanner with a resolution of 300 pixels per inch. But the same one pixel specification corresponds to a placement tolerance of only about 10 microns for a scanner with a resolution of 2400 pixels per inch.

Pending U.S. patent application Ser. No. 09/365,112, having a common assignee with the present application, describes a method of compensating for die placement errors in a handheld scanner. However, that application describes only a particular compensation method requiring position sensors and a position correction system.

An efficient method is needed to compensate for assembly and alignment errors in a multi-segment sensor assembly.

### SUMMARY OF THE INVENTION

A method and apparatus are disclosed for compensating for assembly and alignment errors in multi-segment sensor assemblies. The placement of each sensor segment is characterized by the coordinates of its end pixels in scanner pixel space. This characterization may optionally be done by measurement of the sensor assembly outside the scanner, or by scanning a measurement target. For each segment, an offset is computed for the segment's first pixel, indicating the number of scan lines the pixel should be shifted to place its data in the image pixel nearest its ideal location. The slope of the segment is calculated, and any points are calculated along the length of the segment where the offset should change. During scanning of an image, image data is placed in a buffer with enough image lines to span the entire sensor assembly. The data may be moved to an output destination. Upon placement into the buffer or the output destination, image data from each interval of the segment is shifted by the integer number of scan lines in the subscanning direction that minimizes image artifacts caused by assembly and alignment errors. In an alternative embodiment, interpolation is performed between two adjacent scan lines to approximate shifting data by non-integer numbers of scan lines. Where sensor segments overlap in the main scanning direction, the data from two overlapping segments may optionally be smoothed by combining data from redundant pixels in weighted proportions.

### BRIEF DESCRIPTION OF THE DRAWINGS

FIG. 1 depicts a perspective view of the imaging portion of a scanner using a contact image sensor (CIS).

FIG. 2 depicts a cross-section view of the CIS arrangement of FIG. 1, as it would be used to scan a reflective original.

FIG. 3 depicts a schematic plan view of a particular sensor segment.

FIG. 4 depicts the pixels from three sensor segments as projected onto an original.

FIG. 5 depicts an exaggerated example of misplacement of the sensor segments.

FIG. 6 depicts the sensor segments of FIG. 5 and their corresponding position characterization.

FIG. 7 depicts an example memory buffer appropriate for the simplified sensor arrangement of FIG. 6.

FIG. 8 shows the buffer of FIG. 7 with pixels from one sensor segment in place.

FIG. 9 depicts the buffer with the pixels from all three segments in place after a first scan line.

FIG. 10 shows the buffer after three scan lines have been completed.

FIG. 11 depicts the positions of two successive scan lines seen by one sensor segment and illustrates interpolation.

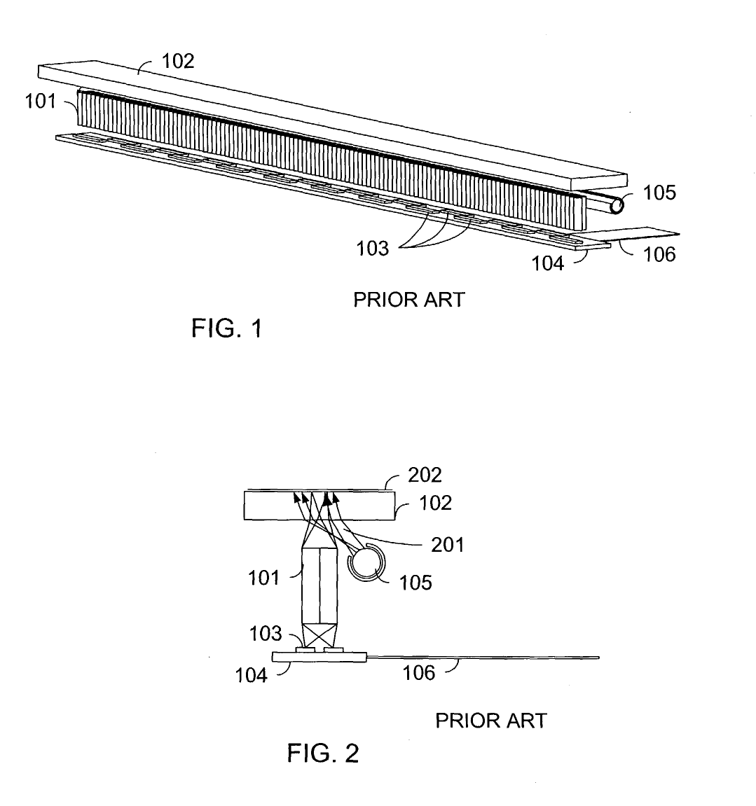

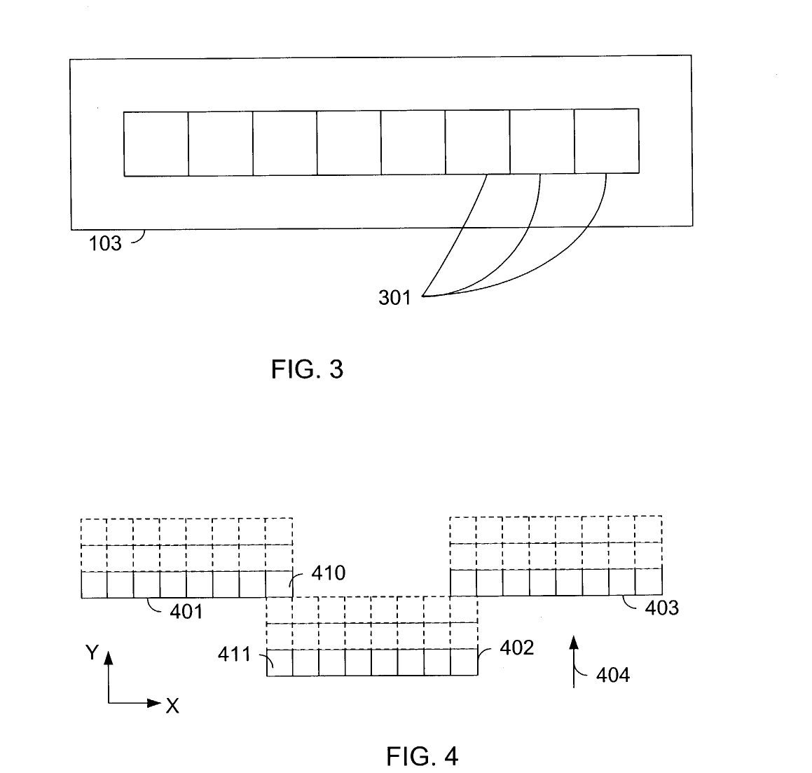

### DETAILED DESCRIPTION OF THE PREFERRED EMBODIMENT

A first step in compensating for assembly and alignment errors is to characterize the positions of the sensor segments. A preferred characterization is to locate the end pixels of each segment in scanner pixel space. This may be accomplished by measuring the completed sensor assembly using metrology equipment and transferring the measurements along with the sensor assembly into a product.

Alternatively, the segment positions may be characterized by scanning a known target and analyzing the resulting image to infer the segment positions. A method of this kind is disclosed in a companion application to this one, having a common assignee and filed on the same day with applicant docket number 200207836-1. That application is hereby incorporated by reference for all that it teaches.

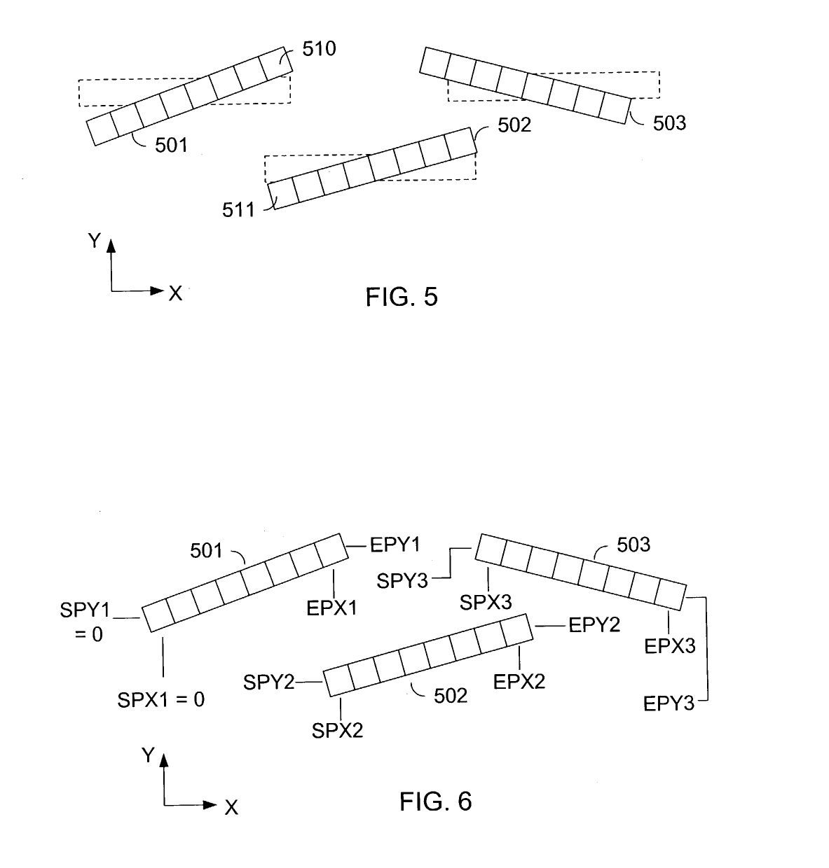

FIG. 6 depicts the sensor segments of FIG. 5 and their corresponding position characterization. The upper row of segments, of which segments 501 and 503 are representative, may be considered the odd row, and the lower row, represented by segment 502, may be considered the even row. The leftmost pixel of each segment is that segment's starting pixel, and the rightmost pixel of a segment is that segment's ending pixel. The position of a segment is completely characterized by specifying the X and Y coordinates of both the starting and ending pixel. These coordinates are designated as follows:

SPXn—starting pixel X coordinate for nth segment

SPYn—starting pixel Y coordinate for nth segment

EPXn—ending pixel X coordinate for nth segment

EPYn—ending pixel Y coordinate for nth segment.

For the example shown in FIG. 6, segments 501, 502, and 503 are associated with n=1, 2, and 3 respectively. The coordinates are assumed to be normalized such that SPX1=0 and SPY1=0. That is, the starting pixel of segment 501 serves as the origin for the measurements. In the example of FIG. 6, the measurements in pixels may be

| | |
|---|---|
| SPX1 = 0 | SPY1 = 0 |
| EPX1 = 6.6 | EPY1 = 2.6 |
| SPX2 = 6.8 | SPY2 = −2.6 |
| EPX2 = 13.6 | EPY2 = −0.6 |
| SPX3 = 12.4 | SPY3 = 2.4 |
| EPX3 = 19.2 | EPY3 = 0.4 |

As an image is scanned, digital data may be placed into a memory buffer. The buffer must be large enough to hold as many scan lines as are required to cover the extreme Y-direction pixel locations of all the sensor segments. For example, in the example of FIG. 6, the extremes are defined by EPY1 and SPY2. EPY1=2.6 and SPY2=−2.6. ROUND(EPY1)−ROUND(SPY2)=6, so the buffer should contain seven or more lines of data. Sensor segments comprising multiple rows sensitive to different sets of light wavelengths may be used to provide a color scanning capability. In that case, the buffer size should encompass the extreme Y-direction pixel locations of all sensor segments of all colors. Alternatively, a separate buffer may be provided for each color.

While this specification describes the compensation in terms of a single color, one of skill in the art will recognize that the method may easily be applied in a scanner with color capability, and that such an application will fall within the scope of the appended claims.

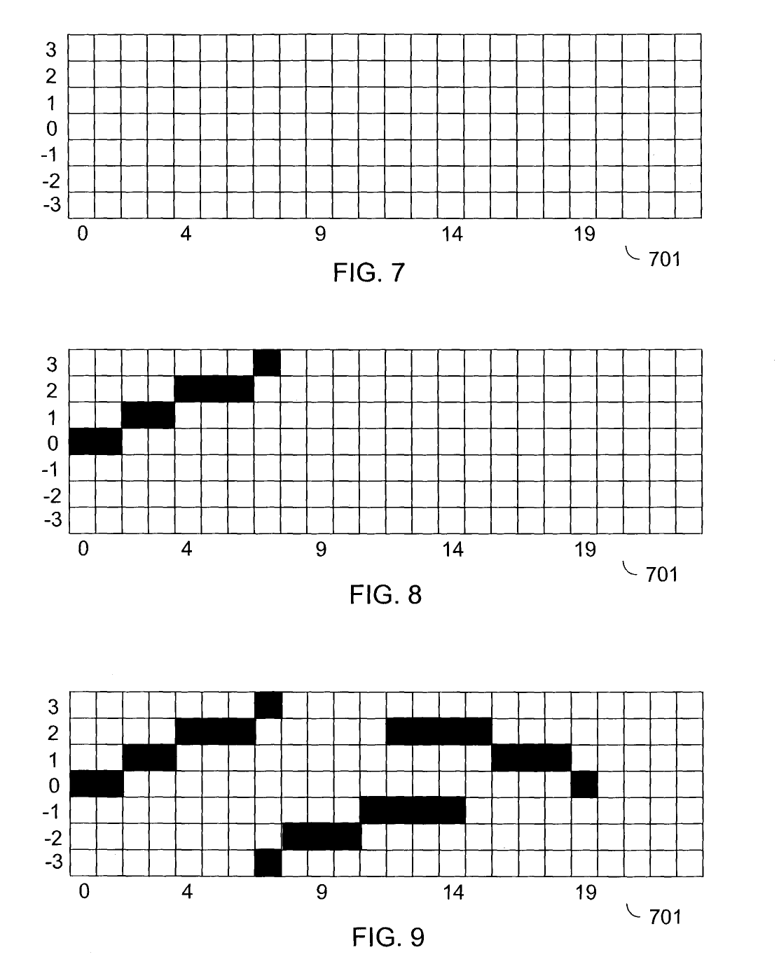

FIG. 7 depicts a memory buffer 701 appropriate for the simplified sensor arrangement of FIG. 6. Each element of the array holds a numerical value representing the reflectance or transmittance of a corresponding location on original 202. This numerical value may also be called a pixel. For simplicity of reference, a particular line of buffer 701 has been designated line 0, and the other lines numbered correspondingly. Other numbering schemes may be used.

The buffer may be part of a scanner, or in a host computer connected to the scanner. Similarly, the computations and data movement involved in embodying the invention are typically performed on a microprocessor system that may reside in a scanner or in a host computer. Specialized hardware may assist the microprocessor.

In a first example algorithmic embodiment of the invention, an object is to place each numerical pixel value in the buffer element most closely corresponding to the actual pixel location on original 202. In the absence of any compensation method, the numerical values from a particular sensor segment would be placed in the same row of the buffer 701. When a compensation method in accordance with an example embodiment of the invention is used, the numerical values from a particular sensor segment may span several rows of buffer 701.

For each sensor segment, a value DeltaYn is computed. DeltaYn=ROUND(EPYn−SPYn). In the example of FIG. 6,

DeltaY1=ROUND(2.6−0)=3

DeltaY2=ROUND(−0.6−−2.6)=2

DeltaY3=ROUND(0.4−2.4)=−2

If a particular segment has a DeltaYn value of zero, then all of the numerical values from that segment will be placed into the same row in buffer 701. However, these example values indicate that the pixels from segment 501 will fall into four different rows of buffer 701, and pixels from segments 502 and 503 will fall into three different rows each. For example, a few pixels near the starting end of segment 501 will fall in buffer row 0, and few may fall in buffer row 1, a few in buffer row 2, and a few in buffer row 3. These sets of pixels may be thought of as being offset by 0, 1, 2, and 3 rows from the starting pixel row. By computing the pixel number at which the transitions occur between the offsets, it can be determined which pixels of each segment fall into which buffer rows. Computing the transition points for those segments where DeltaYn is not zero proceeds as follows.

A slope Mn and an intercept Bn are computed for each sensor segment.

Mn=(EPYn−SPYn)/(EPXn−SPXn)

Bn=SPYn−Mn*SPXn

Then for each offset, the transition pixel number is calculated as

Transition pixel=CEILING((ROUND(SPYn)+offset−0.5−Bn)/Mn) for DeltaYn<0 CEILING((ROUND(SPYn)+offset+0.5−Bn)/Mn) for DeltaYn>0

For segment 501 in the example of FIG. 6,

M1=(2.6−0)/(6.6−0)=0.3939

B1=0−0.3939*0=0

| Offset | Transition pixel number |
|---|---|
| 1 | 2 |
| 2 | 4 |
| 3 | 7 |

That is, pixels 0 and 1 will fall in the same buffer row as the starting pixel, row 0. Pixels 2 and 3 will fall in row 1, pixels 4, 5, and 6 will fall in row 2, and pixel 7 will fall in row 3. Buffer 701 with the pixels from segment 501 in place is shown in FIG. 8. Because SPX1 is the origin of the scan line in the X direction, the starting pixel of segment 501 falls in column 0 of buffer 701. The pixels having the same offset value may be called an interval or range, and the offset value for that range of pixels may be called a range offset distance.

Similarly, for segment 502

M2=(−0.6−−2.6)/(13.6−6.8)=0.2941

B2=−2.6−0.2941*6.8=−4.6

| Offset | Transition pixel number |
|---|---|
| 1 | 8 |
| 2 | 11 |

Note that the transition pixel number refers to the column of buffer 701. Because SPX2=6.8 and SPY2=−2.6, the first pixel of segment 502 will be placed in row −3, column 7 of buffer 701. The pixels falling in row −2 will span columns 8-10, and the pixels falling in row −1 will complete the segment.

Similarly, for segment 503

M3=(0.4−2.4)/(19.2−12.4)=−0.2941

B3=2.4−−0.2942*12.4=6.05

| Offset | Transition pixel number |
|---|---|
| −1 | 16 |
| −2 | 19 |

FIG. 9 depicts buffer 701 with the pixels from all three segments placed into buffer 701 after the first scan line.

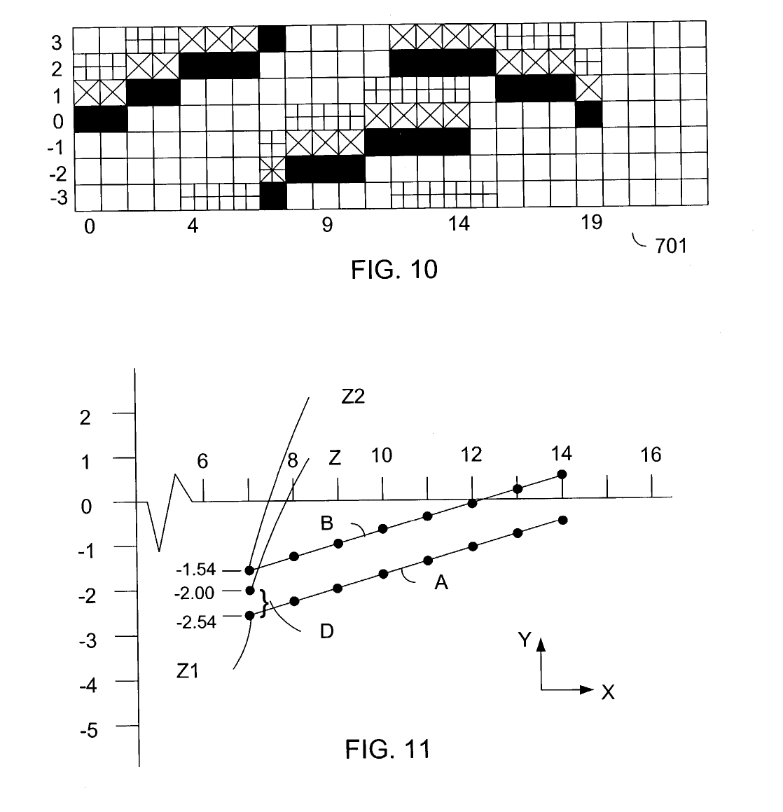

After the first scan line is scanned and its numerical values placed in buffer 701, the scanning mechanism progresses to subsequent scan lines, and their resulting numerical values are placed into buffer 701. FIG. 10 depicts buffer 701 after the first three scan lines have been completed. Pixels filled by values from the first scan line have been blackened in the diagram. Pixels filled by values from the second scan line are shown with an “X”, and pixels filled by values from the third scan line are shown with a “+”. Note that the buffer 701 may be thought of as circular. As lines progress past line 3 of the buffer 701, their pixels are placed in the bottommost line and progress upward. For example the pixel from segment 501 in column 7 appears in row −3 after the second scan line, although its “X” is obscured by the blackened element resulting from the first pixel of segment 502 from the first scan line.

Once seven scan lines have been completed, all of the pixels in segments 501, 502, and 503 will have scanned portions of original 202 corresponding to buffer row 3. Buffer row 3 will then be complete, and the data from row 3 may be sent to an image file, display, printer, or other output destination for storage or presentation. The memory used to store buffer row 3 is then free to accept data from later scan lines.

Because the sensor segments typically overlap in the X direction, certain columns of the image will be scanned by pixels from more than one sensor segment. In the example shown in FIG. 10, column 7 is scanned by segment 501 and then by segment 502 at a later time. Similarly, columns 12-14 are scanned by segment 503 and then again by segment 502 at a later time. The system implementing the example algorithmic embodiment of the invention may handle this situation in one of several ways. In a simple implementation, it may choose to keep the later pixels scanned by the even-row segments and discard the redundant pixels scanned earlier by the odd-row segments. It may choose to keep the earlier pixels scanned by the odd-row segments and discard the redundant pixels scanned later by the even-row segments. It may choose to keep the data from one row of segments for some sets of redundant pixels and from the other row of segments for other sets of redundant pixels.

Alternatively, the system may smooth the transition between the areas scanned by the various segments by computing a weighted value for each pixel scanned by redundant sensors. The weighted value may be a combination of the values from the two segments covering each affected pixel. For example, in the example of FIG. 10, the system may fill column 7 of buffer 701 by averaging data values from segment 501 from earlier-scanned lines with data values from segment 502 from later-scanned lines of the same pixel. When the overlap between segments is more than one pixel, such as the overlap between segments 502 and 503 in the example, it may be desirable to weight the pixels in shifting proportion to their proximity to the ends of the respective segments. In any case, the redundant pixels may be identified by computing a die pair overlap value

DPOn=EPXn−SPX(n+1)+1

This value gives the number of redundant pixels at the end of the nth segment.

In a second example algorithmic embodiment of the invention, the system may further refine the values placed into buffer 701 by interpolating between successive scan lines in the Y direction. FIG. 11 depicts the positions of two successive scan lines seen by segment 502. Using the slope and intercept values previously calculated, an equation giving the Y-direction locations of pixels on segment 502 for the first scan line is

Y=0.2941 X−4.6

The next scan line is offset from the first by one pixel, and thus an equation giving the Y-direction locations of pixels on segment 502 for the second scan line is

Y=0.2941 X−3.6

Segment 502 spans pixel columns 7-14 in the X direction. Typically for a particular column, neither of the pixels in two successive scan lines falls exactly on a pixel location in the coordinate system referenced to the origin pixel. This second algorithmic embodiment combines pixel data from two successive scan lines that fall on either side of an origin-referenced pixel to estimate the numerical value that would have resulted had one of the scan lines exactly crossed that origin-referenced pixel location.

For example, in image column 7, for the scan line labeled A, the first pixel of segment 502 reads a Y location of −2.54. Scan line B, one line later, reads a Y location of −1.54. If Z1 is the numerical value read by the pixel in scan line A and Z2 is the numerical value read by the same pixel in scan line B, then the value placed in column 7, row −2 of buffer 701 is a weighted average of Z1 and Z2. The weighting is in proportion to the proximity of the two lines to the nominal pixel location. For example, in FIG. 11, D is the fractional part of the column 7 pixel location in scan line A, so that D=0.54. This represents the distance from the nominal pixel location to the column 7 pixel location in scan line A. The value placed into buffer 701 column 7 row 3 is

Z=(1−D)*Z1+D*Z2

This interpolation process is repeated for the other pixels in the scan lines.

In this second example algorithmic embodiment, the two most recent scan lines are kept to enable the interpolation before placing pixel values into buffer 701. As the data is placed into buffer 701, the system implementing the method may make similar choices as in the first example algorithmic embodiment as to how to handle redundant pixels caused by the overlap of the sensor segments. The first- or last-occurring pixels may be chosen, or the system may smooth the transition between sensor segments by weighting the contributions of the pixels from adjacent segments.

The foregoing description of the present invention has been presented for purposes of illustration and description. It is not intended to be exhaustive or to limit the invention to the precise form disclosed, and other modifications and variations may be possible in light of the above teachings. For example, the scanned values may be placed into the buffer in their uncompensated locations and the compensation could be applied at the time the values are extracted from the buffer and sent to a final image file or other device. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of compensating for assembly and alignment errors in a multi-segment sensor assembly comprising the steps of:
a) computing, from the positions of a plurality of segments in a multi-segment sensor assembly, for each pixel in each segment, a corresponding subscanning direction offset calculated to reduce image stitching artifacts;
b) scanning a line of data;
c) placing data from the scanned line into a buffer; and
d) sending the data from the buffer to an output destination, each pixel offset from its scanned location by its corresponding subscanning direction offset.

2. The method of claim 1 wherein the step of computing a corresponding subscanning direction offset further comprises the steps of:
a) computing a number of offsets used by each segment;
b) computing a range offset distance corresponding to each of the number of offsets;
c) computing a first pixel offset for a first pixel in each segment;
d) calculating a slope of each segment;
e) ascertaining, from the slope and first pixel offset of each segment, transition pixels demarking ranges of pixels in each segment such that all the pixels in each range require the same offset distance.

3. The method of claim 1 wherein placing the data from the scanned line into the buffer further comprises offsetting each pixel from its scanned location by its corresponding subscanning direction offset.

4. The method of claim 1 wherein the step of sending the data from the buffer to an output destination further comprises offsetting each pixel from its scanned location by its corresponding subscanning direction offset.

5. The method of claim 1 further comprising the step of discarding redundant pixel values scanned by one of a pair of overlapping sensor segments.

6. The method of claim 1 further comprising the step of combining data from redundant pixels scanned by a pair of overlapping sensor segments.

7. The method of claim 1 wherein the step of computing a corresponding subscanning direction offset further comprises the step of interpolating between successive scan lines.

8. The method of claim 1 wherein the multi-segment sensor assembly is a contact image sensor.

9. A scanner, comprising:
a) a multi-segment sensor assembly;
b) a microprocessor system; and
c) a buffer;
the microprocessor system configured to use characterizations of the positions of a plurality of segments in the multi-segment sensor assembly to perform the following method:
i. computing, for each pixel in each segment, a corresponding subscanning direction offset calculated to reduce image stitching artifacts;
ii. scanning a line of data;
iii. directing data from the scanned line into a buffer; and
iv. sending the data from the buffer to an output destination, each pixel offset from its scanned location by its corresponding subscanning direction offset.

10. The scanner of claim 9 wherein the multi-segment sensor assembly is a contact image sensor.

11. The scanner of claim 9 wherein the microprocessor system is assisted by specialized hardware.

12. The scanner of claim 9 wherein computing, for each pixel in each segment, a corresponding subscanning direction offset comprises:
a) computing a number of offsets used by each segment;
b) computing a range offset distance corresponding to each of the number of offsets;
c) computing a first pixel offset for a first pixel in each segment;
d) calculating a slope of each segment;
e) ascertaining, from the slope and first pixel offset of each segment, transition pixels demarking ranges of pixels in each segment such that all the pixels in each range require the same offset distance.

13. The scanner of claim 9 wherein computing, for each pixel in each segment, a corresponding subscanning direction offset further comprises interpolating between successive scan lines.

14. A computer system comprising:
a) a host computer;
b) a scanner connected to the host computer;
c) a buffer;
the computer system configured to use characterizations of the positions of each of a plurality of segments in the multi-segment sensor assembly to perform the following method:
i. computing, for each pixel in each segment, a corresponding subscanning direction offset calculated to reduce image stitching artifacts;
ii. scanning a line of data;
iii. directing data from the scanned line into the buffer; and
iv. sending the data from the buffer to an output destination, each pixel offset from its scanned location by its corresponding subscanning direction offset.

15. The computer system of claim 14 wherein the buffer resides in the scanner.

16. The computer system of claim 14 wherein the buffer resides in the host computer.
